(19) United States
(12) Patent Application Publication
(10) Pub. No.: US 2018/0073508 A1
(43) Pub. Date: Mar. 15, 2018

(54) Preloaded Bearing

(71) Applicant: Eaton Corporation, Clevealnd, OH (US)

(72) Inventors: Jason Brady, Livonia, MI (US); Benjamin Sheen, Schoolcraft, MI (US)

(73) Assignee: Eaton Corporation, Clevealnd, OH (US)

(21) Appl. No.: 15/558,926

(22) PCT Filed: Jan. 27, 2016
(86) PCT No.: PCT/US16/15095

§ 371 Date: Sep. 15, 2017

Related U.S. Application Data
(60) Provisional application No. 62/133,829, filed on Mar. 16, 2015.
(60) Provisional application No. 62/174,286, filed on Jun. 11, 2015.
(60) Provisional application No. 62/174,287, filed on Jun. 11, 2015.

(51) Int. Cl. F04C 18/12; F16C 25/08; F02B 33/38

(52) U.S. Cl. CPC F04C 18/126; F04C 2240/50; F02B 33/38; F16C 25/08

(57) ABSTRACT

A supercharger comprises a housing, a gear box, and a shaft. The shaft comprises a first end and a second end, wherein the first end is located closer to the gear box than the second end. The supercharger comprises a shaft bore comprising a base wall, wherein the second end of the shaft is located in the shaft bore. The supercharger comprises a rotor bore in the housing and a rotor located on the shaft in the rotor bore. The rotor comprises an axis. The supercharger comprises a bearing surrounding the shaft and located closer to the second end of the shaft than the first end of the shaft, wherein the bearing comprises an outer ring abutting the shaft bore and an inner ring abutting the shaft. The supercharger comprises a biasing device abutting the bearing, wherein the biasing device moves the rotor along the axis.

### FIELD

This application relates to preloaded bearings and provides for a supercharger housing with preloaded rotor bearings.

### BACKGROUND

Twin screw and Roots superchargers are subject to chatter and other vibration errors as the rotors spin in the housing. The vibrations can be caused by tolerance stack-ups, they can be temperature dependent as parts expand and contract, they can be driven by shaft instabilities, whirl, internal bearing slip at contact surfaces and rattle within assembly clearances. Vibrations can be along the rotor axis or perpendicular to it. When a bearing is mounted to the rotor shafts, the bearings can squeal in response to the vibrations or in response to temperature-sensitive tolerances.

Clearances in the rotor bore and bearing assemblies are a source of vibration. The clearances allow the rotor to move in the axial and radial direction and vibrate. The movement and vibration can result in reduced performance and objectionable noise. Also, the rotors can contact the rotor bore, resulting in coating wear and damage to both the rotors and the rotor bore.

### SUMMARY

The method and devices disclosed herein overcome the above disadvantages and improve the art by way of a supercharger housing adapted to preload a bearing.

A supercharger comprises a housing, a gear box, and a shaft. The shaft comprises a first end and a second end, wherein the first end is located closer to the gear box than the second end. The supercharger comprises a shaft bore comprising a base wall, wherein the second end of the shaft is located in the shaft bore. The supercharger comprises a rotor bore in the housing and a rotor located on the shaft in the rotor bore. The rotor comprises an axis. The supercharger comprises a bearing surrounding the shaft and located closer to the second end of the shaft than the first end of the shaft, wherein the bearing comprises an outer ring abutting the shaft bore and an inner ring abutting the shaft. The supercharger comprises a biasing device abutting the bearing, wherein the biasing device moves the rotor along the axis.

A supercharger comprises a housing, a first shaft, a second shaft, a rotor bore in the housing, a first rotor located on the first shaft in the rotor bore, a second rotor located on the second shaft in the rotor bore, and a first helical gear connected to the first shaft. The first helical gear comprises a plurality of helical teeth. The supercharger comprises a second helical gear connected to the second shaft. The second helical gear comprising a plurality of helical teeth.

A method for assembling a supercharger comprises fixing a rotor to a shaft, wherein the shaft comprises an axis. The method comprises installing a biasing device into a shaft bore, wherein the biasing device abuts a base wall. The method comprises installing the rotor into a rotor bore, installing the shaft into the shaft bore, installing a bearing into the shaft bore, installing the bearing onto the shaft, and applying a force against the bearing with the biasing device, thereby moving the rotor along the axis.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

It is to be understood that both the foregoing general description and the following detailed description are exemplary and explanatory only and are not restrictive of the claimed invention.

### BRIEF DESCRIPTION OF THE DRAWINGS

FIG. 1 is a cross-section view of a supercharger with a preloaded bearing with preload force aligned with boost force.

FIG. 2A is a graph showing a load pattern of supercharger rotor during a operating cycle operating without a biasing device.

FIG. 2B is a graph showing a load pattern of supercharger rotor with a preloaded bearing during an operating cycle.

FIG. 3 is a cross-section view of a supercharger with a preloaded bearing with preload force opposing boost force.

FIG. 4 is a cross-section view of the inlet side of a supercharger with a preloaded bearing.

FIGS. 5A-5C show bearing ball position and contact angle in response to axial loads.

FIG. 6 is a view of a rotor assembly.

### DETAILED DESCRIPTION

Reference will now be made in detail to the examples, which are illustrated in the accompanying drawings. Wherever possible, the same reference numbers will be used throughout the drawings to refer to the same or like parts. Directional references such as “left” and “right” are for ease of reference to the figures.

When a bearing is mounted to the rotor shafts of a supercharger, the bearings can squeal in response to vibrations, temperature-sensitive tolerances, or tolerance stack-up. Another cause for noise is boost load, where the variation in pressure of air moving through the housing as the rotors turn causes changes in magnitude and orientation of load against the rotors. This may also include unloaded conditions, in which the changes in magnitude and direction of rotor load caused by the boost load can also similarly vary the bearing load. The load can be along the rotor axis or perpendicular to it. Preloading the bearing helps solve this problem by minimizing operating bearing clearances, thus, reducing unwanted noise and vibration.

Clearances in the bearings and gear box of a supercharger can cause the rotor to move during operation. This movement can be in the form of vibration, axial displacement, radial movement, or a combination of the all these movements. As a result of this movement, the rotor can rub or hit against the housing, wearing off coatings and damaging the rotor. This can result in decreased performance because the damaged rotor loses volumetric efficiency. It can also lose symmetry, becoming less stable when rotating.

This movement can also cause undesirable noise, vibration, and harshness (NVH), especially when the supercharger operates in cold environments, for example, at temperatures near −40 degrees centigrade. This noise is sometimes called “hoot noise” or “squeal.”

The movement can also cause undesirable noise, vibration, and harshness at high temperatures. The housing and parts of a supercharger can reach temperatures exceeding 200 degrees centigrade during operation. Thus, a supercharger must be designed to operate within a wide range of temperatures, for example, within a range of −40 degrees centigrade to 200 degrees centigrade.

The change in temperature causes the rotor to move because the rotor and other parts expand when the temperature increases and contract when the temperature decreases. Parts are often made from different materials, including aluminum and steel. Because the parts are made from different materials, they expand and contract at different rates.

When exposed to cold temperatures, the housing can contract, resulting in less clearance between the rotor and the housing. This increases the risk that the rotor contacts the housing.

The rotor can also move due to mechanical strain on the rotor and bearings. These strains are caused by loads experienced during operation, for example, loads caused by boost pressure and thrust from helical gears.

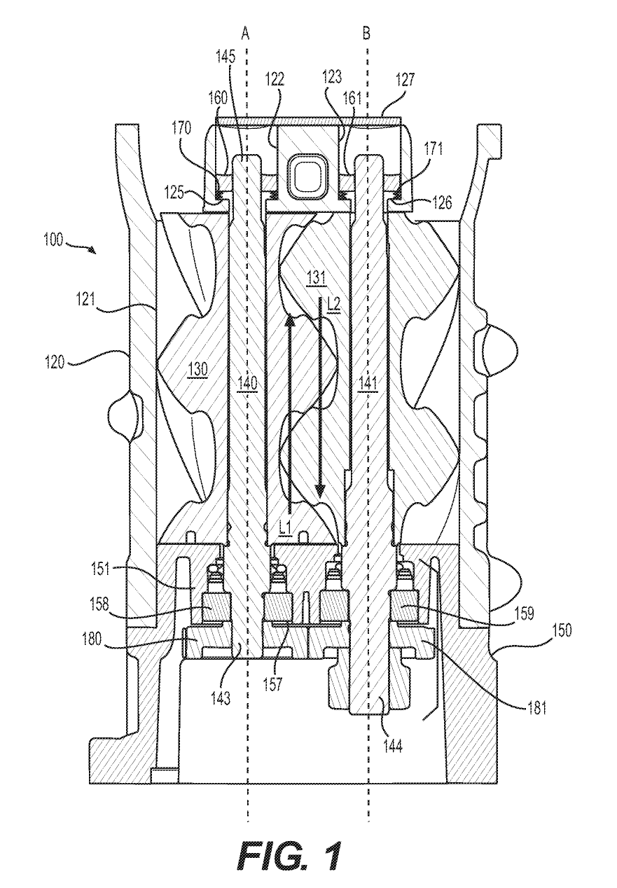

When the bearing is preloaded in line with the load placed on the rotors via the boosting process, as shown in FIG. 1, the biasing device tugs on the mechanisms in the gear case, which locks the rotors in place. This reduces the chatter and restricts the axial motion of the rotors. By locking the rotors in place via the preload, other system modifications can be made, such as balancing the helix angle of the gears in the gear case, or adjusting the angle of the rotor lobes.

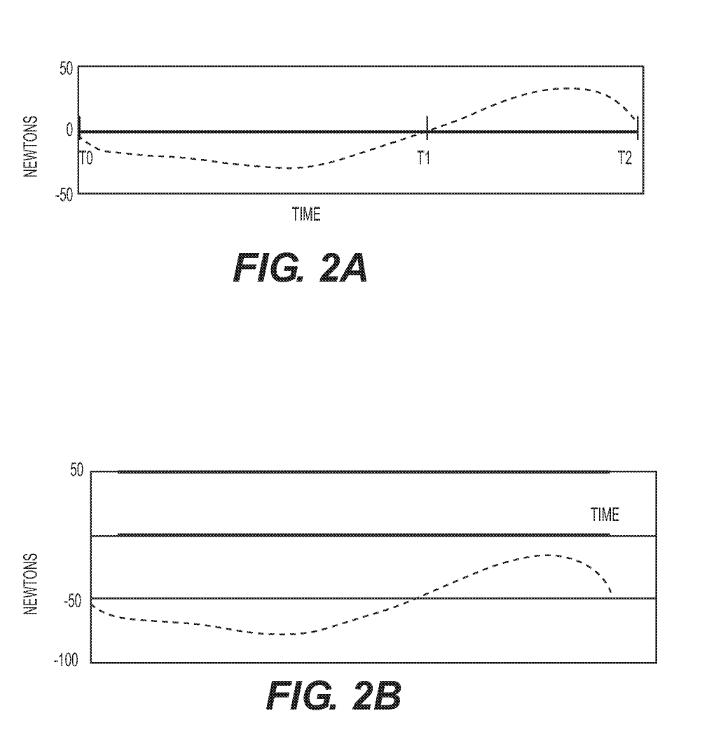

FIG. 1 shows a cross-section of a supercharger 100 with bearings 160, 161 around shafts 140, 141. Shafts 140, 141 are connected to rotors 130, 131. Rotors receive power from gear box 150, which can be attached to a pulley, motor, or other torque transfer mechanism. The load on the rotors changes in both direction and magnitude during operation, such as when the device shifts between a positively loaded condition and a negatively loaded condition. For example, during the operating cycle of a supercharger, the load on rotor 130 can be in the direction of either L1 or L2. For example, the load can be related to the pressure waves of the charge air as it is swept through the rotor bore. The pressure waves can oscillate and cause oscillations in the axial loads L1, L2. If bearing 160 is not preloaded, the load on the rotor can be zero when the supercharger initially starts up, then increase in the direction of L1, then decrease until it reaches zero again, then increase in the direction of L2. FIG. 2A depicts an example of such a load pattern. The vertical axis represents the force on the second bearings 158, 159 (located in gear box 150) in Newtons. The horizontal axis represents time.

Gears 180, 181 can be helical gears. Helical gear 180 has the same lead as helical gear 181. Lead is the axial advance of a helix for one complete turn. Lead can be calculated using equation (1), where

$${p}_{z} = π \frac{z * {m}_{n}}{sin β} \qquad eq . ( 1 )$$

p_{z}=axial lead

z=number of teeth

mₙ=normal module

β=helix angle

Helical gears 180, 181 can also rotate at the same rate of speed as rotors 130, 131 even when rotors 130, 131 move axially due to changes in axial load, for example, due to changes in thrust force and boost pressure.

FIG. 2A shows that the axial load is 0 N at time T0. Between T0 and T1, the load is negative. Between T1 and T2 the load is positive. The load never exceeds 50 N in either the positive or negative direction. A negative load would act in the opposite direction as a positive load. For example, a negative load acts in the direction of L1 and a positive load acts in the direction of L2, as shown in FIG. 1. This variance in magnitude and direction of the load on rotors 130, 131 causes rotors 130, 131 to move back and forth along axes A, B.

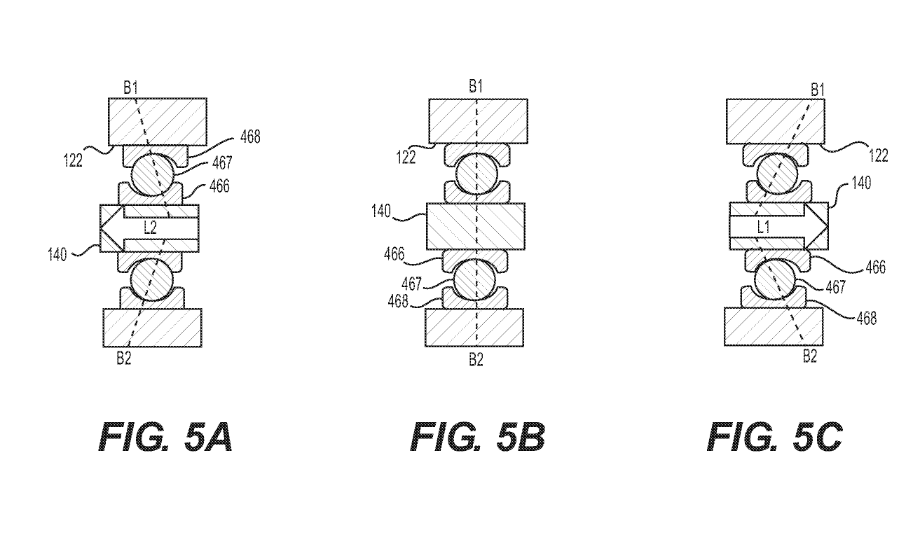

In FIGS. 5A-5C, a bearing assembly 460 is shown in a shaft bore 122. Axial load L1 pushes the shaft 140 toward the rotor side of the housing. Axial load L2 tugs the shaft 140 towards the gear box 150. The bearing axis B1, B2 are vertical when the axial loads are balanced, and the balls 467 seat centered between the inner ring 466 and the outer ring 468. A radial inner clearance (RIC) is the space the ball can shift between the inner ring and outer ring. When the axial load L2 tugs the rotor 130, the affiliated rotor shaft 140 tugs the inner ring 466 towards the gear box 150. When the axial load L1 pushes the rotor 130, as in FIG. 5C, the rotor shaft 140 pushes the inner ring 466 away from the gear box 150. The bearing axes B1, B2 tilt oppositely to FIG. 5A. FIG. 5B, with axis B1 aligned with axis B2, represents a condition where the rotor shaft 140 experiences no or little axial load. Squeal can occur under a no load or low load condition, so it is beneficial to use the preload of biasing devices 170, 171 to maintain one of the arrangements in FIG. 5A or 5C during no load or low load conditions.

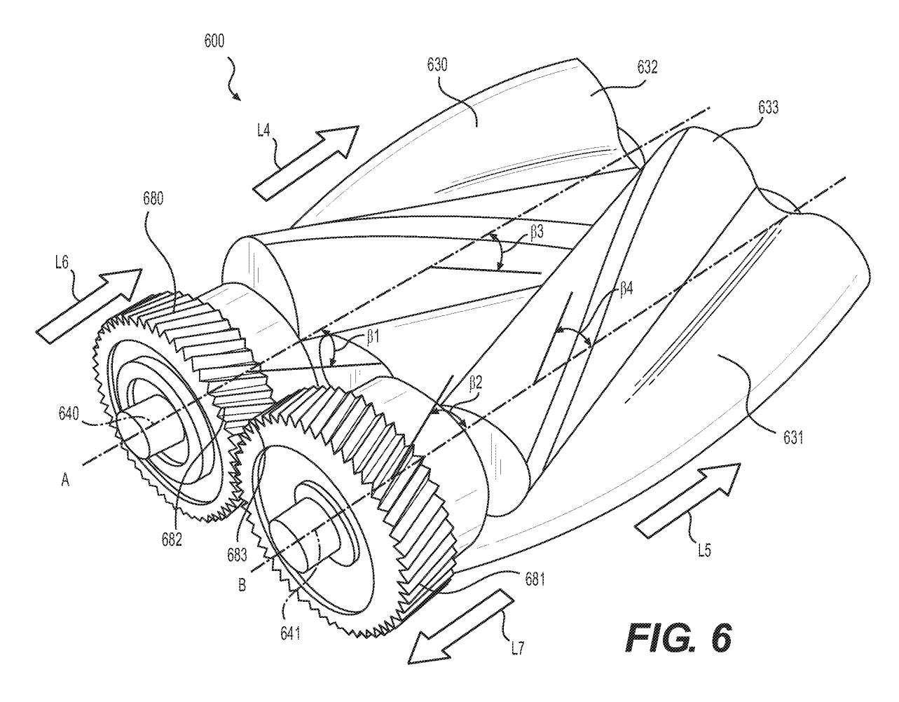

FIG. 6 shows an example of axial loads on rotor shafts 640, 641 during operation. Helical gear 680 is the drive gear and helical gear 681 is the driven gear. Helical gear 680 can receive torque from a pulley, motor, engine, or other torque transfer device. Forces L4, L5 represent boost forces acting away from helical gears 680, 681 along rotors 630, 631. Thrust forces L6, L7 exist when helical gears 680, 681 rotate. Because helical gear 680 is the drive gear, the direction of the thrust force L6 is in the same direction as boost force L4. Thrust force L7 acts in the opposite direction of boost force L5. When the opposite loads equal each other, for example, when thrust force L7 equals boost force L5 in magnitude, a net zero load exists. This creates unwanted noise and vibration. The zero-load condition can also cause the rotors to move backwards and forwards in the axial direction as allowed by clearances such as internal clearances in the bearings.

Helical gears 680, 681 can rotate at the same rate as the rotors 630, 631. One feature of an axial-inlet, radial-outlet supercharger is that the rotors 630, 631 have a helical twist along axes A, B. Rotors 630, 631 have a plurality of lobes, for example, lobes 632, 633. Lobes 632, 633 are helices. Lobes 632, 633 have helix angles with respect to axes A, B. All the lobes have the same magnitude helix angle, but the helix angle β3 of lobes 632 on rotor 630 are opposite in direction from the helix angle β4 of lobes 633 on rotor δ31. For example, helix angles β4 and β3 are equal in magnitude, but β4 is negative and β3 is positive when rotor 630 is right-handed and rotor 631 is left-handed. They also have the same magnitude lead, which can be calculated using equation (1).

Helical gears 680, 681 also have a twist along axes A, B. Helical gears 680, 681 have teeth, for example, teeth 682, 683. Teeth 682, 683 are helices. Like lobes 632, 633, teeth 682, 683 have a helix angle with respect to axes A, B. All the teeth have the same magnitude helix angle, but the helix angle β1 of teeth 682 on helical gear 680 are opposite in direction from the helix angle β2 of teeth 683 on helical gear 681. For example, helix angles β2 and β1 are equal in magnitude, but β2 is negative and β1 is positive when helical gear 680 is right-handed and helical gear 681 is left-handed. The helix angles β2, β1 of teeth 682, 683 on helical gears 680, 681 need not be of the same magnitude as the helix angles β4, β3 of lobes 632, 633 on rotors 630, 631. All the teeth 682, 683, however, have the same lead magnitude as the lead magnitudes of lobes 632, 633.

Gears 680, 681 can be called timing gears. The configuration of the rotor assembly 600 maintains the timing of the rotating rotor group independent of the axial movement of rotor shafts 640, 641. Both gears 680, 681 and rotors 630, 631 twist at the same rate of angular displacement. When gears 680, 681 are synchronized with rotors 630, 631, gears 680, 681 rotate rotor shafts 640, 641 at the same rate as rotors 630, 631, even as the rotor shafts 640, 641 move axially (such as due to bearing internal clearances). In addition, any thermal growth such as axial growth along rotor shafts 640, 641 can occur at the same rate. In this regard, the clearances (gap or channel) between the rotors 630, 631 can be maintained without compromising the rotor coating or reducing efficiency.

The axial movement of shaft 640 can cause helical gear 680 to rotate helical gear 681. And the axial movement of the shaft 641 can cause helical gear 681 to rotate helical gear 680. In the arrangement shown in FIG. 6, any thrust loads and axial movement of rotor shafts 640, 641 will not change the timing of the rotor assembly 600. In this regard, rotor shafts 640, 641 move very little if at all in directions away from axes A, B. This helps prevent rotors (for example, rotors 130, 131 of FIG. 1) from striking housing 120, which can damage the rotors and reduce efficiency. Because rotors 130, 131 move very little if at all in directions away from axes A, B, one can design a supercharger with tighter clearances between the rotors 130, 131 and housing 120.

When helical gears 180, 181 are used instead of conventional spur gears, the timing of the rotation of rotors 130, 131 remains independent of the axial movement. Spur gears have a helix angle equal to zero. The teeth are not helices, but instead, the teeth in a spur gear are parallel to the shafts axes, for example, axes A, B in FIG. 1, 3, or 6. Because the teeth are parallel to axes A, B, they are also parallel to shafts 140, 141. Thus, the gaps between the teeth of spur gears allow the shafts and rotors to move axially toward and away from the spur gears when the spur gears are located where helical gears 180, 181 are positioned. Force due to boost pressure can cause this axial movement. Unlike helical gears, spur gears do not create axial thrust when rotating. Biasing devices 170, 171 can be used to reduce noise, vibration, and axial movement caused by the thrust force produced by helical gears 180, 181.

As discussed above using helical gears instead of spur gears also helps better maintain the clearance between the rotors and the housing, improving efficiency and preventing damage. Using helical gears also reduces the noise that often accompanies spur gears.

In one test condition, it was shown that a conventional rotor arrangement, not preloaded by a bearing, can move as much as 0.066 mm when operating at 120 degrees Centigrade and as much as 0.100 mm at 150 degrees Centigrade. Adding a preload of 50 N to bearings 160, 161 in the direction of boost (axial load L1 direction) reduced the axial displacement to a total displacement of 0.013 mm at 120 degrees Centigrade and 0.008 mm at 150 degrees Centigrade. Other results are possible depending upon radial internal clearances of the bearing and boost forces.

FIG. 2B shows a load pattern on a rotor surrounded by a bearing preloaded with 50 N of force. In FIG. 2B, the load on the rotor does not change direction. It is always in negative territory. This means that the rotor is always biased toward bearing 160, eliminating much of the back and forth movement and reducing the total axial displacement. The balls 467 better maintain their position between inner ring 466 and outer ring 468.

The preload can be greater or less than 50 N. One can select the amount of the preload to fit needs of the supercharger. For example, a rotor might experience loads of 75 N during operation. Thus, a preload of more than 75 N can be used to keep the rotor biased toward bearings 160, 161 thereby reducing axial displacement and keeping the rotor positioned at its original location.

The preload can depend on the bearing's dynamic load rating. The International Organization for Standardization (ISO) and bearing manufactures publish dynamic load ratings for bearings. The capacity can be defined as a rating. Having too great of a preload can reduce the lifespan of the bearing. One can select a preload high enough to prevent a zero load condition from occurring but low enough to avoid undesirably reducing the lifespan of the bearing. For example, the preload can be less than 2% of the dynamic load rating. The preload can be greater than 0.5% and less than 2% of the dynamic load rating. Thus, for a large bearing, the preload might exceed 50 N, but still be less than 2% of the dynamic load rating.

The preload can be applied by biasing devices 170, 171, as shown in FIG. 1. FIG. 1 shows a supercharger assembly 100 with a housing 120 and rotor bore 121. Inside rotor bore 121 are rotors 130, 131 and shafts 141, 142. Shafts 141, 142 have first ends 143, 144 and second ends 145, 146. When used with helical gears 680, 681, the spring preload applied by the biasing devices 170, 171 can be a function of the helix gear angle.

Biasing devices 170, 171 can be compression springs, such as wave springs, coils springs, leaf springs, Belleville springs, or disc springs, or other biasing devices. Biasing devices 170, 171 can abut base walls 125, 126 and bearings 160, 161 as shown.

When installed in an axial-inlet, radial outlet supercharger housing 120, the flow pattern through the housing impacts the size of the bearings 160, 161 and the preload of biasing devices 170, 171. For example, a radial-inlet, radial-outlet supercharger can accommodate larger loads on the rotors, and larger bearings in the base walls. The larger design can use larger springs. But, an axial-inlet, radial-outlet supercharger must use smaller bearings to avoid restricting the size of the axial inlet. The change in size of the bearings is not straightforward to implement. The smaller bearings spin faster, but give up load capacity. The biasing devices must be selected for the smaller size, as by reducing the preload. And, the angles of rotors 130, 131 are adjusted, which impacts the helix angles of helix gears 680, 681.

Shaft 140 is attached to bearing 160 and rotor 130. Thus, when biasing device 170 pushes against bearing 160, it pulls shaft 140 and rotor 130 in the direction of L1 along axis A. Likewise, biasing device 171 pulls shaft 141 and rotor 131 along axis B.

The first end 143 of shaft 140 is located in gear box 150. Shaft 141 can be surrounded by second bearing 158 near first end 143. When shaft 140 is pulled in the direction of L1, it moves in the direction of L1 along axis A. This locks shaft 140 and rotor 130 in place, eliminating play allowed by clearances in gear box 150 and second bearing 158. Second bearing 158 can be fixed to gear box housing 151 via an interference fit. This prevents the outer surface 157 of second bearing 158 from moving in the axial direction, but internal bearing components, for example, rollers and inner races, have clearances that allow play.

Bearing 160 can be slip-fit into shaft bore 122. This allows biasing device 170 to push bearing 160, shaft 140, and rotor 130 away from second bearing 158 along axis A.

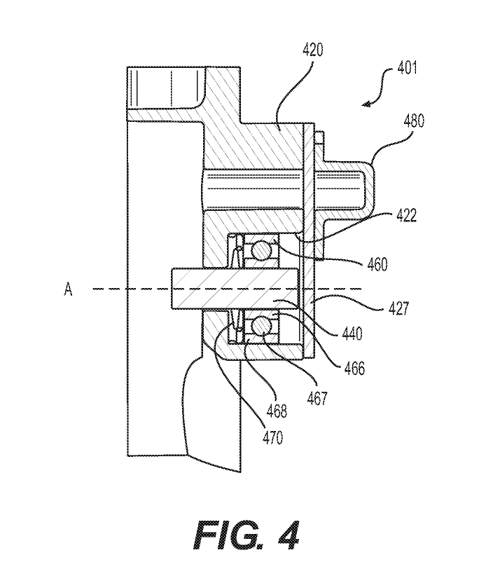

Conventional superchargers use needle bearings. In the present disclosure, bearings 161, 162 can be deep groove ball bearings. Using ball bearings instead of needle bearings can reduce the axial length and cost of the supercharger. Ball bearings can be less prone to the high motion and noise that accompanies needle bearings. FIG. 4 shows bearing 460 with balls 467 as rollers. Using balls 467 permits higher rotations per minute (RPMs) of the rotor shaft, which permits an end user to use a smaller sized supercharger to reach boost loads compared to needle bearing arrangements.

One can close shaft bores 122, 123 with cover plate 127 after installing the bearings 160, 161 and biasing devices 170, 171 in shaft bores 122, 123. Cover plate 127 can be attached by welding, bolting, screwing, or other fastening methods.

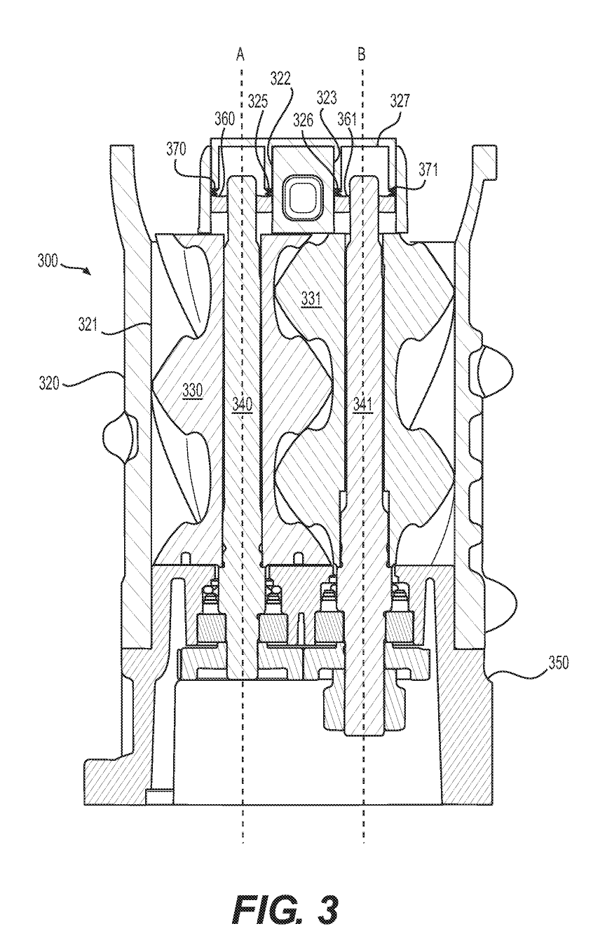

FIG. 3 shows the preloaded force opposed to the boost. The bearing is preloaded to oppose the boost load. This pushes the bearing, and hence the rotor shaft. The biasing device then pushes back against the boost load, but also reduces chatter and restricts axial motion of the rotors. However, this arrangement allows for more axial travel of the rotors than the arrangement in FIG. 1. Rotor stability is improved via the arrangements of FIGS. 1 and 3, and so system performance improves.

FIG. 1 shows an arrangement where biasing devices 170, 171 apply a preloaded force in the same direction as the axial load experienced due to boost pressure. Boost pressure pushes the rotors in the direction of L1 along axes A, B. FIG. 3 shows an arrangement where biasing devices 370, 371 apply a preloaded force in the opposite direction as the axial load experienced due to boost pressure. This arrangement can bias rotors 330, 331 and shafts 340, 341 in place by pushing on components in gear box 350. Biasing devices 370, 371 can also dampen vibrations, reducing the overall noise, vibration, and harshness experienced by supercharger 300.

Biasing devices 370, 371 can be installed by placing them in shaft bores 322, 323 from the rotor bore 321. One can first place biasing devices 370, 371 in shaft bores 322, 323, then place bearings 360, 361 in shaft bores 322, 323, and then place shafts 340, 341 in bearings 360, 361, which are already in shaft bores 322, 323. Or one can first place biasing devices 370, 371 and bearings 360, 361 on shafts 340, 341, then place shafts 340, 341 (with bearings 360, 361 and biasing devices 370, 371 surrounding shafts 340, 341) into shaft bores 322, 323. Or one can first place biasing devices 370, 371 into shaft bores 322, 323, then place shafts 340, 341 (with bearings 360, 361 attached to shafts 340, 341) into shaft bores 322, 323. None of these methods requires attaching a separate cover plate over shaft bores 322, 323. Base walls 325, 326 can be built into shaft bores 322, 323 with back wall 327 of shaft bores 323, 324 being an integral part of housing 320.

FIG. 4 shows a section of the inlet side 401 of a supercharger with biasing device 470 preloading bearing 460 in a direction aligned with the load caused by boost pressure. This arrangement includes a cover plate 427 that can be separate from housing 420. Cover plate 427 is fixed to housing 420 covering shaft bore 422. Cover plate 427 can be attached by bolts, screws, welds, or any combination of the above. Using a cover plate 427 allows one to first install the biasing device 470 and bearing 460 into shaft bore 422 before installing shaft 440. After installing biasing device 470 and bearing 460, one can close shaft bore 422 with cover plate 427. Additional features can also be added, for example, recessed plate 480. Recessed plate 480 and cover plate 427 can be attached at the same location, for example, by bolting, screwing, or welding them to housing 420.

Bearing 460 has an outer ring 468 and an inner ring 466. Outer ring 468 can be slip-fit into shaft bore 422. Slip-fitting outer ring 468 allows bearing 460 to more easily move in the axial direction along axis A. Shaft 440 can be press-fit into inner ring 466. With outer ring 468 free to move in the axial direction and inner ring 466 attached to shaft 440, bearing 460 pulls on shaft 440 when preloaded with biasing device 470, locking shaft 440 in place.

Or biasing device 470 can abut outer ring 468, but not inner ring 466. In this arrangement, biasing device 470 pushes against outer ring 468. Outer ring 468 can thereby pull on inner ring 466 via balls 467.

The magnitude of the spring preload of the biasing device is set based on the bearing sizes, application duty cycle, rotor geometry and gear geometry in gear box 150. An ideal spring preload is greater than the sum of the opposing axial loads from the rotor operation to prevent the rotor shaft from traversing the axial internal clearance of the fixed end ball bearing. This better maintains the rotor gaps and prevents excessive coating wear. The spring preload can be in-line (in the same direction) as axial loads, such as boost loads, or the spring preload can be opposing the axial load.

The arrangements above can improve supercharger performance by reducing axial movement of the rotor during operation. Eliminating movement due to clearances in the gear box and bearings improves the stability of the rotors during operation.

Other implementations will be apparent to those skilled in the art from consideration of the specification and practice of the examples disclosed herein. It is intended that the specification and examples be considered as exemplary only, with the true scope of the invention being indicated by the following claims.

1-27. (canceled)

28. A supercharger comprising:
a housing comprising an axial inlet and a radial outlet;
a first shaft extending axially within the housing, the first shaft having a first end and a second end, wherein the first end is located adjacent to the axial inlet and the second end is located adjacent to the axial outlet;
first bearing on the first end of the first shaft, the first bearing comprising a bearing axis that can shift from a vertical position to a range of tilted positions;
a second shaft extending axially within the housing, the second shaft having a first end and a second end, wherein the first end is located adjacent to the axial inlet and the second end is located adjacent to the axial outlet;
a second bearing on the first end of the second shaft;
a rotor bore in the housing;
a first rotor located on the first shaft in the rotor bore;
a second rotor located on the second shaft in the rotor bore;
a first helical gear connected to the second end of the first shaft, wherein the first helical gear comprises a first plurality of helical teeth;
a second helical gear connected to the second end of the second shaft, wherein the second helical gear comprises a second plurality of helical teeth in meshing engagement with the first plurality of helical teeth; and
a first biasing device preloading the first bearing to remain within the range of tilted positions when the first rotor rotates.

29. (canceled)

30. The supercharger of claim 29, wherein the first helical gear comprises a lead magnitude and the second helical gear comprises a lead magnitude, wherein the first helical gear and the second helical gear have the same lead magnitude.

31. The supercharger of claim 30, wherein the first helical gear and the second helical gear rotate at the same angular speed as the first rotor.

32. The supercharger of claim 30, wherein the first rotor comprises a rotor lead, and wherein the lead of the first helical gear is the same as the first rotor lead.

33. (canceled)

34. The supercharger of claim 28, wherein axial movement of the first shaft causes the first helical gear to rotate the second helical gear.

35. (canceled)

36. The supercharger of claim 28, further comprising a clearance between the first rotor and the second rotor, wherein the clearance between the first and second rotors is maintained after one of the first or second rotor shafts moves axially.

37. The supercharger of claim 28, wherein: the first rotor has lobes with a first lead; the second rotor has lobes with a second lead; the teeth on the first helical gear have a third lead; the teeth on the second helical gear have a fourth lead; and the first lead, the second lead, the third lead, and the fourth lead are equal in magnitude.

38-49. (canceled)

50. The supercharger of claim 28, wherein the biasing device is one of a wave spring, coil spring, leaf spring, Belleville spring, or disc spring.

51. The supercharger of claim 28, wherein the bearing is a deep groove ball bearing.

52. The supercharger of claim 28, wherein the bearing comprises an inner ring, an outer ring, and bearing balls between the inner ring and the outer ring, and wherein the biasing device abuts the outer ring of the bearing.

53. The supercharger of claim 52, wherein the housing further comprises a shaft bore for housing the first bearing and the first end of the first shaft, and wherein the outer ring of the bearing can move in the shaft bore.

54. The supercharger of claim 28, wherein the housing further comprises a shaft bore for housing the first bearing and the first end of the first shaft, wherein the bearing comprises an inner ring, an outer ring, and bearing balls between the inner ring and the outer ring, and wherein the outer ring of the bearing and the shaft bore are attached by an interference fit.

55. The supercharger of claim 28, wherein the first helical gear and the second helical gear rotate at the same speed as the rotor.

56. The supercharger of claim 28, wherein first biasing device exerts a force against the first bearing of less than 2% of the first bearing's dynamic load rating.

57. The supercharger of claim 28, wherein first biasing device exerts a force against the first bearing of greater than 0.5% but less than 2% of the first bearing's dynamic load rating.

58. The supercharger of claim 28, wherein the first biasing device exerts a force of 50 Newtons or less against the first bearing.

59. The supercharger of claim 28, wherein the first biasing device exerts a force of 75 Newtons or less against the first bearing.

60. The supercharger of claim 28, wherein the first biasing device biases the first rotor in a direction away from the outlet.

61. The supercharger of claim 28, wherein the first biasing device biases the first rotor in a direction towards the outlet.

62. The supercharger of claim 28, further comprising a third bearing on the second end of the first shaft.
